(19) United States
(12) Patent Application Publication
(10) Pub. No.: US 2025/0148934 A1
(43) Pub. Date: May 8, 2025

(54) Training Simulator to test proper compression pressure of straps

(71) Applicant: Michael C. Dimino, Freehold, NJ (US)

(72) Inventor: Michael C. Dimino, Freehold, NJ (US)

(21) Appl. No.: 18/743,490

(22) Filed: Jun. 14, 2024

Related U.S. Application Data
(60) Provisional application No. 63/521,094, filed on Jun. 15, 2023.

(51) Int. Cl. G09B 23/28; G01L 5/04; G09B 5/02

(52) U.S. Cl. CPC G09B 23/28; G01L 5/04; G09B 5/02

(57) ABSTRACT

The present invention relates to a training simulator designed to improve the accuracy and efficiency of strap application techniques, specifically in medical settings. The simulator features a user-friendly interface with a compressible apparatus and an integrated LCD display for real-time visual feedback. It incorporates advanced pressure sensing technology to accurately measure and monitor compression pressure applied during strap usage. Immediate feedback is provided through visual and auditory cues, ensuring users achieve the desired compression range. The system also includes data logging and analysis capabilities, enabling users to track their performance over time. Wireless connectivity and virtual reality integration allow for remote collaboration and real-time virtual training sessions, fostering global knowledge exchange. Additionally, the simulator offers customizable training modes for various skill levels and specific medical procedures. This invention provides a comprehensive and innovative solution for improving strap application techniques through hands-on practice, immediate feedback, and advanced technological integration.

### FIELD OF THE INVENTION

The present invention relates to a training simulator for strap applications, specifically targeting the improvement of techniques associated with applying straps in medical settings. The simulator provides immediate feedback on achieving the correct compression pressure during strap application, ensuring accuracy and efficiency. Additionally, it incorporates wireless connectivity and virtual reality capabilities to enable real-time virtual training and global collaboration.

### BACKGROUND OF THE INVENTION

Strap applications, such as the securing of items, devices, or materials with straps, are widely employed in various medical procedures. However, achieving the correct compression pressure during strap application can be challenging, often resulting in inadequate or excessive pressure, leading to reduced effectiveness or discomfort to the patient. Furthermore, there is a growing need for training solutions that leverage technology to enable virtual training experiences and global collaboration.

### SUMMARY OF THE INVENTION

The training simulator for strap applications described herein is a comprehensive system that allows users to simulate real-world scenarios, practice various strap applications, and receive immediate feedback on the achieved compression pressure. The simulator comprises the following key components:

Strap Application Interface: The simulator includes a user-friendly interface that replicates the physical environment encountered during strap applications. It features a compressible apparatus with a lcd display that provides visual feedback. The interface accommodates different strap widths, lengths, and materials to ensure a realistic training experience.

Pressure Sensing Technology: The simulator incorporates advanced pressure sensing technology that accurately measures the compression pressure applied during strap applications. The sensors are strategically placed within the simulator's interface to capture data in real-time.

Feedback System: To provide immediate feedback, the simulator is equipped with a visual and/or auditory feedback system. Users can observe graphical representations or receive audio cues indicating the achieved compression pressure. The feedback system is calibrated to reflect the desired range of compression pressure based on specific medical procedures.

Data Logging, Analysis, and Wireless Connectivity: The training simulator includes a data logging and analysis feature that enables users to track their progress over time. Additionally, the simulator has wireless connectivity capabilities, allowing it to link up to multiple devices on an online server. This feature enables real-time virtual training and global collaboration, introducing a level of virtual reality. Users from around the world can pair up for real-world stimulation training, enhancing the training experience and promoting knowledge exchange.

Training Modes: The simulator offers multiple training modes to cater to different skill levels and medical applications. Users can select from beginner, intermediate, or advanced modes, each featuring a progressively challenging set of strap application scenarios. Additionally, the simulator may include training modules tailored to specific medical procedures.

In conclusion, the training simulator for strap applications with compression pressure feedback provides an innovative solution for individuals in the medical field to enhance their strap application skills. By incorporating wireless connectivity and virtual reality capabilities, the simulator enables real-time virtual training and global collaboration, revolutionizing the way strap applications are taught and practiced.

### DESCRIPTION OF DRAWING

FIG. 1

This figure shows the medical strap compression trainer.

### DETAILED DESCRIPTION OF DRAWINGS

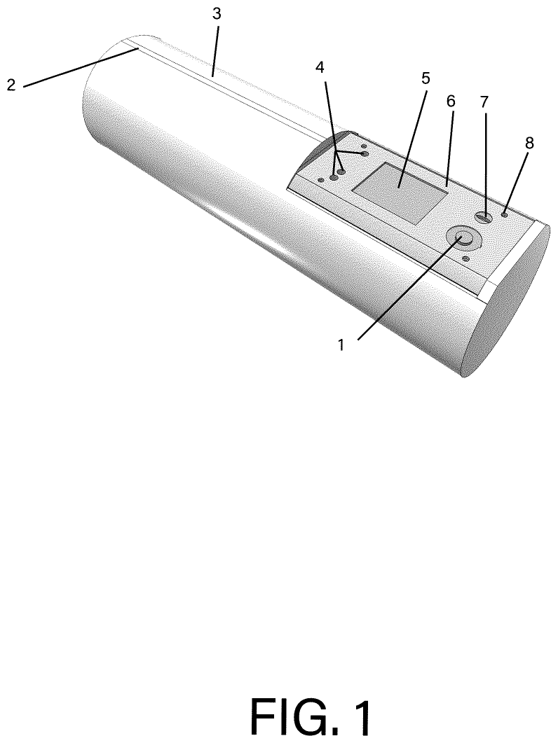

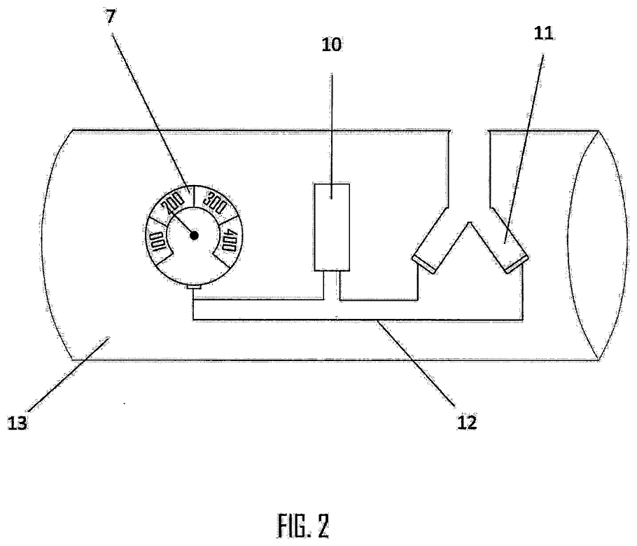

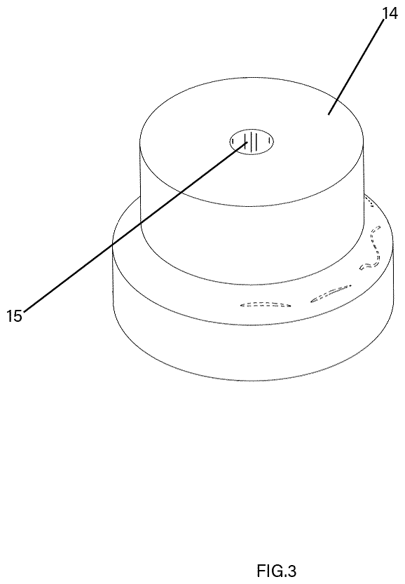

FIG. 1
#1 shows the power button to turn the device on
#2 shows the sensor location that measures the strap compression.
#3 shows the outer layer of the trainer where the strap is wrapped around.
#4 shows the LED readout locations.
#5 shows the display monitor.
#6 shows the Control board faceplate.
#7 shows the Charging port.
#8 shows the screw pilot to secure the control board to the body.

FIG. 2
#9 Analog dial
#10 Sensor diaphragm
#11 Cavity
#12 Tubing
#13 Roller

FIG. 3

#14 Training Surface
#15 Compression Cavity

1. A portable learning device consisting of a compressible cylinder with multiple layers of silicone, foam, and plastic.

2. According to claim 1, the device is shaped in the form of a cylinder and a platform.

3. According to claim 2, the device is shaped as a cylinder allowing straps to be wrapped around the device to test compression strength.

4. According to claim 3, the device is compressible allowing tension to increase under the strap causing an increase of pressure which tests the strength of the overall strap or medical strap.

5. According to claim 4, the increase of tension is noted by a sensor or force sensor embedded within the device measuring the pressure from the applied strap.

6. According to claim 5, the embedded sensor reads the pressure and relays it to the onboard controller.

7. According to claim 6, the onboard controller relays the information through a display attached to the device or wireless device that can be monitored remotely.

8. According to claim 7, the information provided shows the user if the strap has been adequately applied to the device or if more pressure is needed. The display will also relay to the user to stop tightening once adequate pressure has been achieved.

9. According to claim 7, the onboard computer will also send visual cues through LEDs which will light up corresponding to the correct scenario.

10. According to claim 9, the LEDs will light up as follows; red will be that no pressure has been applied, yellow will be that more pressure needs to be applied, and green is that adequate pressure has been applied and no further compression is needed.

11. According to claim 1, The Device has a weighted internal stabilizer.

12. According to claim 11, The internal cylinder will act as stabilizer which allows the device to always stay in an upright position with the display always facing upward.

13. A portable tension device consisting of a ridged cylindrical type of roller, the roller has four sections that interlock with each other by male and female channels, the device contains air bladders that interface with a MMHG dial. The strap to be tested are placed around the roller over the air bladders, as the straps are tightened the bladder is defused into the analog dial meter where the pressure is converted into MMHG and may include PSI measurement.

14. A learning device that can test internal pressure.

15. According to claim 14, the device is comprised of an internal channel with a sensor to measure internal pressure.

16. According to claim 15, the device measures internal using a visual feedback system comprised of LED indicators and or a display.

17. Device can excrete fluid in order to visually demonstrate leaking in order to give feedback if strap compression is adequate.

18. According to claim 17, if the fluid continues to excrete more pressure from the strap is needed. When fluid has stopped the correct pressure has been applied.
